(19) United States
(12) Patent Application Publication
(10) Pub. No.: US 2012/0257713 A1
(43) Pub. Date: Oct. 11, 2012

(54) Non-Destructive Analysis of an Object

(76) Inventors: Julien Baptiste Pierre Noel, Minneapolis, MN (US); Eric Ferley, Minneapolis, MN (US)

(21) Appl. No.: 13/432,604

(22) Filed: Mar. 28, 2012

Related U.S. Application Data
(60) Provisional application No. 61/472,333, filed on Apr. 6, 2011.

(51) Int. Cl. G01N 23/04

(52) U.S. Cl. 378/19

(57) ABSTRACT

A computed tomography (CT) scanning system performs non-destructive analysis of an object. The CT scanning system generates a series of two-dimensional images of the object from different angles as the object rotates. The CT scanning system uses the generated two-dimensional images to reconstruct three-dimensional images of the object. By displaying several reconstructed three-dimensional images over time, the CT scanning system generates a four-dimensional representation of the object.

### FIELD OF THE INVENTION

The present invention relates to industrial computed tomography, and more specifically, to a dynamic industrial computed tomography scan system allowing for non-destructive analysis of an object as well as a method for such analysis.

### BACKGROUND OF THE INVENTION

In the last few years, industrial computed tomography (CT) has seen significant developments in various applications including quality inspection and three-dimensional metrology of critical manufacturing parts. Most of these developments have been focused on resolution, algorithms, and the quality and flexibility of systems. One of the greatest improvements is the speed at which a complete CT scan can now be performed. A few years ago, a complete industrial cone-beam CT scan would take hours or even days and most of the time only provides results in two-dimensional CT slices and low quality images.

### SUMMARY OF THE INVENTION

In general terms, this disclosure is directed to industrial four-dimensional CT scanning. In one possible configuration and by non-limiting example, reconstructed three-dimensional CT scan images of an object are animated over time for non-destructive analysis/testing of the object.

One aspect is a CT scanning method for non-destructive analysis of an object. The method includes rotating the object. The method also includes radiating the object as the object is being rotated in a continuous or step-by-step manner. In addition, the method comprises generating measurements of radiation that has passed through the object as the object is being rotated. The method also includes using the measurements to generate two-dimensional (2D) images of the object. Each of the 2D images is captured after the object has rotated a different number of degrees. In addition, the method includes reconstructing three-dimensional (3D) images of the object from the 2D images. The method also includes using the reconstructed 3D images to generate a four dimensional representation of the object. Moreover, the method includes displaying the four dimensional representation of the object.

Another aspect is a CT scanning system for non-destructive analysis of an object. The system includes a radiation source arranged to radiate the object and a detector arranged to measure radiation that has passed through the object. In addition, the system comprises a stage upon which the object is placed. The stage is configured to rotate the object in a continuous or step-by-step manner. The stage is located between the radiation source and the detector. The CT scanning system further includes a control unit configured to use the measurements to generate a series of 2D images of the object, each of the 2D images captured after the object has rotated a different number of degrees; reconstruct 3D images of the object from the 2D two-dimensional images; and use the 3D images to generate a four dimensional representation of the object. A display unit is arranged to display the four-dimensional representation of the object.

A further aspect is a computer readable storage media including program instructions for performing non-destructive analysis of an object. Execution of the program instructions by a CT scanning system causes the CT scanning system to rotate the object in a continuous or step-by-step manner; radiate the rotating object as the object is being rotated; generate measurements of radiation that has passed through the object as the object is being rotated; use the measurements to generate 2D images of the object, each of the 2D images captured after the object has rotated a different number of degrees; reconstruct 3D images of the object from the 2D images; use the 3D images to generate a four dimensional representation of the object; and display the four dimensional representation of the object.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a simplified schematic view of an exemplary CT scanning system according to the present disclosure.

FIG. 2 is a schematic block diagram of the exemplary CT scanning system shown in FIG. 1.

FIG. 3 shows an example of a four-dimensional CT scan in the form of a cup with melting ice.

FIG. 4 shows another example of a four-dimensional CT scan in the form of an hourglass.

FIG. 5 is a flowchart illustrating an exemplary method of operating a four-dimensional CT scanning system according to the present disclosure.

FIG. 6 is a screen illustration of an exemplary setup interface according to the present disclosure.

FIG. 7 is a screen illustration of an exemplary CT scan setup interface according to the present disclosure.

FIG. 8 is a screen illustration of an exemplary four-dimensional reconstruction setup interface according to the present disclosure.

FIG. 9 is a conceptual diagram that illustrates generation of 3D images when a range is set to 90° and an offset value is set to 90°.

FIG. 10 is a conceptual diagram that illustrates generation of 3D images when a range is set to 45° and an offset value is set to 45°.

FIG. 11 is a conceptual diagram that illustrates generation of 3D images when a range is set to 90° and an offset value is set to 45°.

FIG. 12 is a conceptual diagram illustrating subsets of 2D images used to generate 3D images.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE PREFERRED EMBODIMENTS

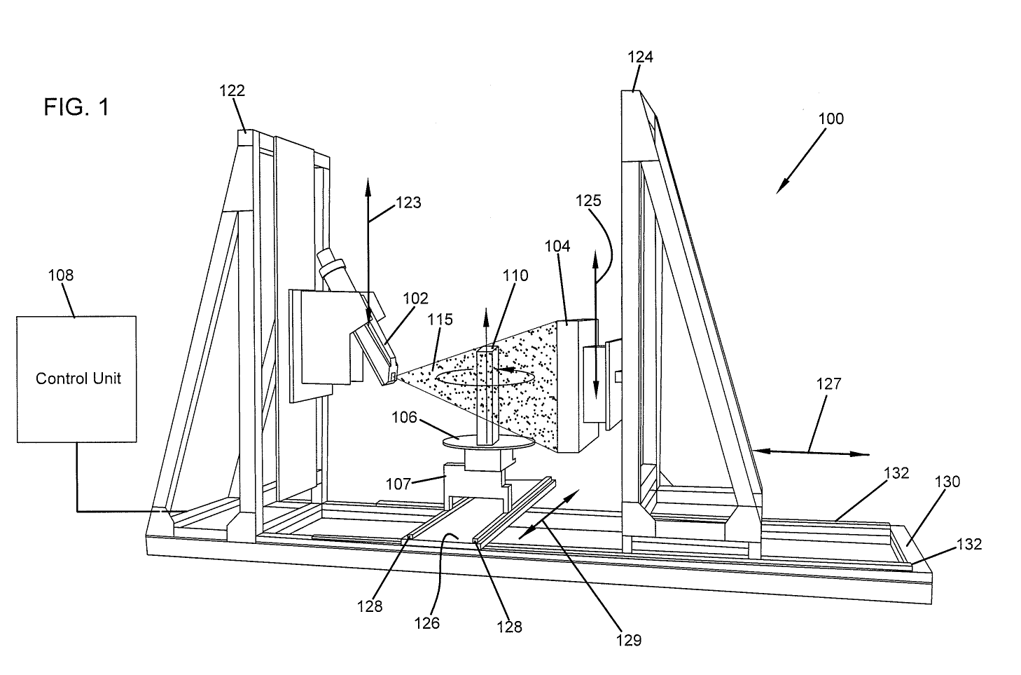

FIG. 1 is a schematic view of an exemplary computed tomography (CT) scanning system 100. The CT scanning system 100 generates four-dimensional (4D) representations of objects. To generate a 4D representation of an object 110, the CT scanning system 100 radiates the object 110 while rotating the object 110 one or more times. As the object rotates, the CT scanning system 100 generates two-dimensional (2D) images of the object 110. The CT scanning system 100 uses the 2D images to generate three-dimensional (3D) images of the object 110. The CT scanning system 100 then generates the 4D representation of the object 110 by animating the 3D images.

As illustrated in the example of FIG. 1, the CT scanning system 100 includes an x-ray source 102, an x-ray detector 104, a stage 106 and a control unit 108. X-ray radiation is a form of electromagnetic radiation having a wavelength between 0.01-10 nanometers. Other types of electromagnetic radiation could also be used. For example, gamma or beta radiation, microwave radiation, or longer wave radiations.

In some embodiments, the x-ray source 102, the x-ray detector 104, and the stage 106 are located in a cabinet (not shown). The control unit 108 is located outside the cabinet, but is connected to the x-ray source 102, the x-ray detector 104, and the stage 106. The cabinet is made from a radiation shielding material, such as lead, a composition of steel-lead-steel, lead-wood, lead-concrete, or only concrete.

The x-ray source 102 comprises an x-ray tube arranged to radiate x-rays onto the object 110 on the stage 106. In one embodiment, the x-ray source 102 comprises a cone-beam x-ray tube that emits x-rays as a cone-shaped beam 115. Examples of industrial x-ray tubes that may be used are nano-focus, micro-focus, mini-focus, open or sealed, transmission or directional, or dual head tubes having a voltage range between 1 kV-16 MeV and a minimum focal spot of about <500 nm. Providers and brands of such x-ray tubes include: Hamamatsu, X-RAY WorX, Feinfocus, Comet, Varian, Yxlon, Phoenix x-ray, Xtek, Viscom, Tohken, and Rigaku.

The x-ray source 102 is movably mounted on an x-ray tube rack 122. The x-ray source 102 is able to move on the x-ray tube rack 122 in a direction illustrated with arrow 123. Moving the x-ray source 102 in the direction illustrated with arrow 123 may allow the CT scanning system 100 to scan objects of various sizes. The x-ray tube rack 122 is mounted on a frame 130.

The stage 106 is positioned between the x-ray source 102 and the x-ray detector 104. To scan the object 110, the user places the object 110 upon the stage 106. Although the object 110 is shown in the example of FIG. 1 as a rectangular block, the reader will appreciate that the object 110 can have other forms. For example, the object 110 can comprise machine components, electronic components, pharmaceutical devices, food, or other types of objects a user wants to analyze.

The stage 106 rotates the object 110. The stage 106 can rotate the object 110 multiple times during creation of the 4D representation of the object 110. In various embodiments, the stage 106 can rotate the object 110 in various manners. For example, the stage 106 can rotate the object 110 in a continuous manner. In other words, the stage 106 can rotate the object 110 without stopping the rotational movement of the object 110. In another example, the stage 106 can rotate the object 110 in a stepwise (i.e. step-by-step) manner. For example, the stage 106 can rotate 5°, stop, rotate another 5°, stop again, and continue on in this manner stopping after every 5° of rotation. The stage 106 may be rotated either manually or by using a motor. In some embodiments, the stage 106 can move up and down while rotating the object 110. Such vertical motion can enable the CT scanning system 100 to generate helical scans of the object 110.

The stage 106 is mounted on a stage support 107. The stage support 107 is movably mounted on rails 128 of a support plate 126 enabling movement in a direction illustrated with an arrow 129. The support plate 126 is movably mounted along rails 132 of frame 130. Consequently, the stage 106 is movable in the direction illustrated by arrow 127. Moving the stage support 107 in the direction of the arrow 129 and moving the support plate 126 in the direction of the arrow 127 may enable the CT scanning system 100 to scan objects of different sizes and may help users mount objects on the stage 106. In other embodiments, the stage 106 is fixed, or not movable in the direction illustrated by the arrow 127 or in the direction illustrated by the arrow 129.

The x-ray detector 104 is arranged on an opposite side of the object 110 from the x-ray source 102. The x-ray detector 104 is arranged to measure x-rays that have penetrated and passed through the object 110. In some embodiments, the x-ray detector 104 is a fast rate digital flat panel comprising a matrix of pixels. In other embodiments, the x-ray detector 104 is an x-ray camera, such as a high speed camera coupled with a scintillator. Example providers and brands of such x-ray detectors include: Varian, Perkin Elmer, Dexela, Hamamatsu, Thales, and Dalsa.

Materials having different densities attenuate x-rays in different ways. For example, some materials partially attenuate x-rays, other materials allow x-rays pass though easily, and other materials block x-rays completely. Thus, the pixels of the x-ray detector 104 are hit by x-ray radiation that has been attenuated differently while passing through the object 110. The x-ray detector 104 transforms the x-ray radiation into electrical signals from which a 2D image of the object 110 is generated.

Various embodiments of the x-ray detector 104 have various frame rates. The frame rate of the x-ray detector 104 indicates the maximum number of 2D images of the object 110 that the x-ray detector 104 is able to generate over the duration of a given time period. In some embodiments, the x-ray detector 104 has a frame rate between 1-200 frames per second. In other embodiments, the x-ray detector 104 is a high-speed detector that has a frame rate of 1000 frames per second or greater.

The x-ray detector 104 is movably mounted on an x-ray detector rack 124. The x-ray detector 104 is able to move on the x-ray detector rack 124 in a direction illustrated with arrow 125. The x-ray detector rack 124 is movably mounted on rails 132 of the frame 130. The x-ray detector rack 124 and the x-ray detector 104 are able to move along the rails 132 in a direction illustrated with the arrow 127. Moving the x-ray detector 104 in the directions of the arrows 125 and 127 may enable the CT scanning system 100 to scan objects of different sizes. In other embodiments, the x-ray detector rack 124 and the x-ray detector 104 are unable to move in the direction illustrated with the arrow 127.

In the example embodiment illustrated in FIG. 1, the x-ray source 102 and the x-ray detector 104 are fixed during scanning while the stage 106 holding the object 110 rotates. However, some embodiments achieve similar results by rotating the x-ray source 102 and the x-ray detector 104 around the object 110 while the object 110 remains stationary.

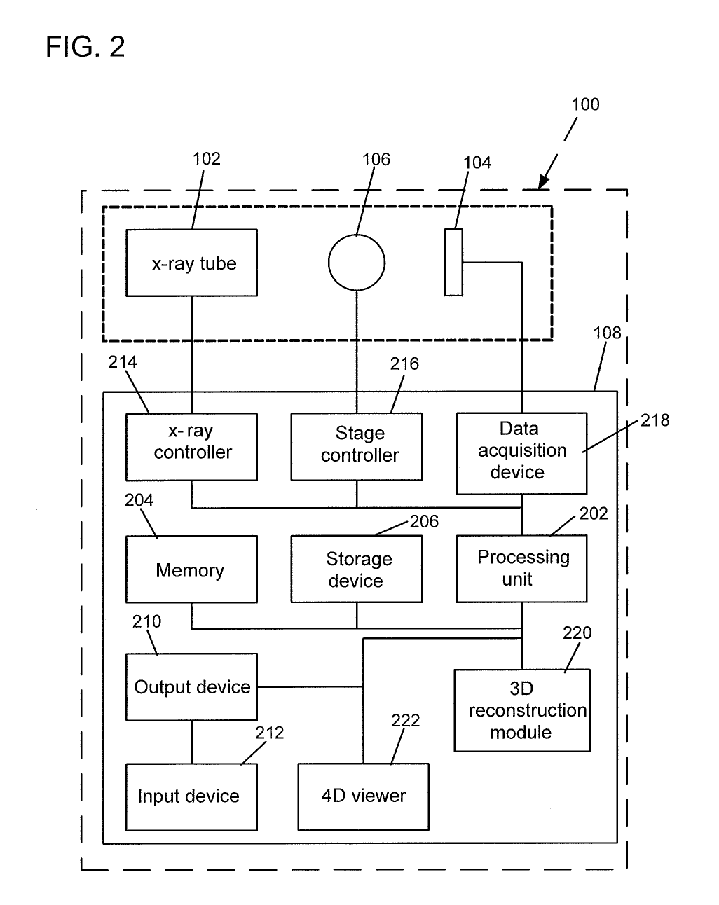

FIG. 2 is a schematic block diagram of an exemplary embodiment of the CT scanning system 100. In the example of FIG. 2, the control unit 108 is implemented as a computing device, such as a personal computer, mainframe computer, a laptop computer, or a work station. It should be appreciated that in other embodiments, the control unit 108 can be implemented as a plurality of computing devices.

As illustrated in the example of FIG. 2, the control unit 108 includes a processing unit 202, a memory 204, a storage device 206, an output device 210, and an input device 212. The control unit 108 also includes an x-ray controller 214, a stage controller 216, a data acquisition module 218, a three-dimensional (“3D”) reconstruction module 220 and a 4D viewer 222.

The processing unit 202 comprises a device that processes instructions. In various embodiments, the processing unit 202 can comprise various types of devices that process instructions. For example, the processing unit 202 can include one or more graphics processing units (“GPUs”). Example types of GPUs include graphics cards by NVIDIA Corporation or ATI Technologies. In some embodiments, the processing unit 202 can comprise several GPU units connected in parallel. In the example of FIG. 2, the GPU is part of the processing unit 202. However, the GPU may be a separate device or may be included in the 3D reconstruction module 220.

In another example, the processing unit 202 can include various other processing units, such as central processing units (“CPUs”), microprocessors, microcontrollers, programmable logic devices, field programmable gate arrays, digital signal processing (“DSP”) devices, specially designed processing devices such as application-specific integrated circuit (“ASIC”) devices, and other devices that process instructions. The processing unit 202 can comprise devices that process instructions belonging to various instruction sets. For example, the processing unit 202 can comprise reduced instruction set computing (“RISC”) devices or complex instruction set computing devices (“CISC”). In some embodiments, the memory 204 is part of the processing unit 202. In other embodiments, the memory 204 is separate from or in addition to memory in the processing unit 202.

The memory 204 and the storage device 206 comprise one or more computer storage media. A computer storage medium is a device or article of manufacture that stores computer-readable data or instructions. Computer storage media include volatile and nonvolatile, removable and non-removable devices or articles of manufacture implemented in any method or technology for storage of information such as computer readable instructions, data structures, program modules or other data. Example types of computer storage media include, but are not limited to, RAM, ROM, EEPROM, flash memory or other memory devices, CD-ROMs, digital versatile discs (DVD) or other optical storage, magnetic cassettes, magnetic tapes, magnetic disk storage or other magnetic storage devices, or any other devices or articles of manufacture that can be used to store information that can be accessed by the control unit 108. Any such computer storage media may be part of control unit 108.

In some embodiments, the memory 204 and/or the storage device 206 store program instructions. Execution of the program instructions by the processing unit 202 can cause the control unit 108 to provide an operating system, one or more application programs, and/or other program modules. Furthermore, execution of the program instructions by the processing unit 202 can cause the control unit 108 to provide the x-ray controller 214, the stage controller 216, the data acquisition module 218, the 3D reconstruction module 220, and the 4D viewer 222. The program instructions may be written in or compiled from various programming languages. Example programming languages include C++, C Sharp, C, Java, Basic, object code, COBOL, GPU programming languages, and other types of programming languages. In other embodiments, the x-ray controller 214, the stage controller 216, the data acquisition module 218, the 3D reconstruction module 220, and/or the 4D viewer 222 can be implemented using special- or general-purpose hardware. For example, the stage controller 216 can comprise a programmable logic controller (PLC). In some instances, the program instructions can be part of a software application or part of a software upgrade that augments functionality of a CT scanning system.

In some embodiments, the control unit 108 includes one or more output devices 210. Example types of output devices include displays, speakers, printers, or other devices that provide output to a user of the CT scanning device 100. In some embodiments, the control unit 108 includes one or more input devices 212. Example input devices include keyboards, mice, pens, voice input devices, touch input devices, or other device that receive input from a user of the CT scanning system 100.

The x-ray controller 214 controls voltage output and current output to the x-ray source 102, thereby controlling the power of the x-rays emitted by the x-ray source 102. The stage controller 216 controls the rotation of the stage 106. The data acquisition module 218 generates two-dimensional images of the object 110 from the x-ray detector 104.

The x-ray detector 104 measures one or more characteristics of x-rays that have passed through the object 110. In various embodiments, the x-ray detector 104 measures various characteristics of the x-rays. For example, the x-ray detector 104 can measure the strength, attenuation, or other characteristics of x-rays that have passed through the object 110.

The x-ray detector 104 uses these measurements to generate a series of 2D images of the object 110. Each of the 2D images is captured after the stage 106 has rotated the object 110 a different number of degrees. For example, the x-ray detector 104 can generate distinct 2D images of the object 110 each time the stage 106 rotates the object 110 one degree. In this example, the x-ray detector 104 generates 360 2D images when the stage 106 rotates the object 110 360°, generates 720 2D images when the stage 106 fully rotates the object 110 twice, and so on. In another example, the x-ray detector 104 can generate distinct 2D images of the object 110 each time the stage 106 rotates the object 110 1/10^{th} of a degree. In this example, the x-ray detector 104 generates 3600 2D images when the stage 106 rotates the object 110 360°, generates 7200 2D images when the stage 106 rotates the object 110 720°, and so on. In some embodiments, the size of each of the 2D images can be between one to ten megapixels or even more. The data acquisition device 218 saves the 2D images in the memory 204, the storage device 206, in a memory in the GPU unit, or in another computer storage medium.

The 3D reconstruction module 220 uses the 2D images of the object 110 to reconstruct 3D images of the object 110. The reconstruction process comprises algorithms that transform the 2D images into a three-dimensional voxels volume image using, for example, GPU-based software. Several algorithms for reconstructing a 3D image from a set of 2D images are known in the art. One example of such an algorithm is based on the Feldkamp, Davis and Kress approximation for cone-beam back-projection, also commonly known as FDK filtered back-projection or FDK filtering. Other examples of such algorithms include Algebraic Reconstruction Technique (ART), Simultaneous Iterative Reconstruction Technique (SIRT), and Simultaneous Algebraic Reconstruction Technique (SART). Because CT scanning is based on the fact that materials of different densities attenuate x-ray radiation differently, it is possible for the 3D reconstruction module 220 to assign different colors to represent each component of the displayed structures or assemblies in the object 110.

The user of the CT scanning system 100 can select a range. The 3D reconstruction module 220 reconstructs 3D images of the object 110 using 2D images captured as the object 110 rotates through the selected range. For example, the user can select a range of 360°. In this example, the 3D reconstruction module 220 can reconstruct a first 3D image of the object 110 using 2D images generated as the object 110 rotates from 0° to 360°. For instance, if the x-ray detector 104 generates a distinct 2D image for each 1° of rotation, the 3D reconstruction module 220 can reconstruct the first 3D image from the 2D images for 0°, 1°, 2° . . . 358°, and 359°. In this example, the 3D reconstruction module 220 can reconstruct a second 3D image of the object using 2D images generated as the object 110 rotates from 10° to 370° (i.e., images for 10°, 11°, 12° . . . 368°, and 369°). In other words, the 3D reconstruction module 220 uses the previously-used 2D images from 10° to 359° and the new images from 360° to 369° to generate the second 3D image. The 3D reconstruction module 220 can continue generating 3D images in this way until the 3D reconstruction module 220 has generated a desired number of 3D images.

In another example, the user can select a range of 180°. In this example, the 3D reconstruction module 220 can generate a 3D image from 2D images generated as the object 110 rotates from 0° to 180°. For instance, if the x-ray detector 104 generate a 2D image for each 1° of rotation, the 3D reconstruction module 220 uses the images for 0°, 1°, 2° . . . 178°, and 179° to generate the first 3D image. In this example, the 3D reconstruction module 220 generates another 3D image from 2D images generated as the object 110 rotates from 90° to 270° (i.e., the 2D images for 90°, 91°, 92° . . . 268°, and 269°). The reader will understand that the user can select other ranges such as 90°, 180°, 270°, or any other number of degrees.

When the 3D reconstruction module 220 reconstructs a 3D image of the object 110 using 2D images generated over longer ranges, the quality of the 3D image may be better. This is because the 3D reconstruction module 220 is able to use more data to reconstruct each 3D image. However, in some circumstances, it may be advantageous to generate 3D images using shorter ranges.

In some embodiments, the 3D reconstruction module 220 enables the user to select an offset value as well as enabling the user to select the range. The 3D reconstruction module 220 uses different sets of 2D images to generate different 3D images. Each 2D image used to generate a 3D image is captured as the object 110 rotates through the selected range. The first 2D images used to generate consecutive 3D images are separated from each other by the offset value. For example, if the offset value is 3° and the selected range is 360°, the 3D reconstruction module 220 uses 2D images from 0° to 360° to generate a first 3D image, the 3D reconstruction module 220 uses 2D images from 3° to 363° to generate a second 3D image, the 3D reconstruction module 220 uses 2D images from 6° to 366° to generate a third 3D image, and so on. Thus, if the x-ray detector 104 generates a 2D image every 0.5 degree, the x-ray detector 104 generates six 2D images each time the object 110 rotates 3°. Furthermore, if the frame rate is set to ten frames per second, there are 600 milliseconds (6 frames/10 seconds) between each reconstructed 3D image.

When reconstructing a given 3D image, the 3D reconstruction module 220 re-uses 2D images that the 3D reconstruction module 220 used to reconstruct earlier 3D images. By reusing 2D images when reconstructing 3D images, the 3D reconstruction module 220 can create more 3D images than if the 3D reconstruction module 220 was only able to generate 3D images using new 2D images. For example, the offset value can be 3°, the selected range can be 360°, and the x-ray detector 104 can generate a 2D image for every 1° that the object 110 rotates. In this example, the 3D reconstruction module 220 generates the first 3D image using the 2D images that were generated while the object 110 rotated between 0° and 360° (i.e., the 2D images for 0°, 1°, 2°, 3°, 4° . . . 358°, 359°). Furthermore, in this example, the 3D reconstruction module 220 generates a second 3D image using the 2D images that were generated while the object 110 rotated between 3° and 363° (i.e., the 2D images for 3°, 4°, 5° . . . 359°, 360°, 361°, 362°). In this way, the 3D reconstruction module 220 uses the 2D images generated while the object rotated between 3° and 360° in both the first 3D image and the second 3D image.

The 4D viewer 222 generates the 4D representation of the object 110 by animating the 3D images over time. The 4D viewer 222 displays the 4D representation of the object 110 on the output device 210. Because the 3D reconstruction module 220 can generate more 3D images than CT scanning devices that do not re-use 2D images to generate 3D images, it may be possible for the user to analyze fast movement of the object 110 or within the object 110. For example, the user may be able to analyze a fluid flowing through the object 110. Furthermore, because the CT scanning system 100 can rotate the object 110 multiple times, it may be possible for the user to analyze movement of or within the object 110 over a time period having indefinite length. Moreover, in embodiments where the object 110 rotates continuously, the CT scanning system 100 can enable the user to analyze movement of or within the object 110 that would be disrupted by stopping and starting movement of the object 110.

In some embodiments, the user can edit the 4D representation of the object 110 in the 4D viewer 222 to show selected 3D images. It is also possible for the user to select and view only parts of the object 110 having a certain density. The user can interact with the animated 3D reconstructions and, for example, display and measure different features or parts of the object. Many options are possible through the use of a four-dimensional CT reconstruction volume image. By virtually cutting a plane of one of the 3D images of the object 110 at a given time, features, parts or defects inside the object 110 may be displayed or measured without destroying the object 110.

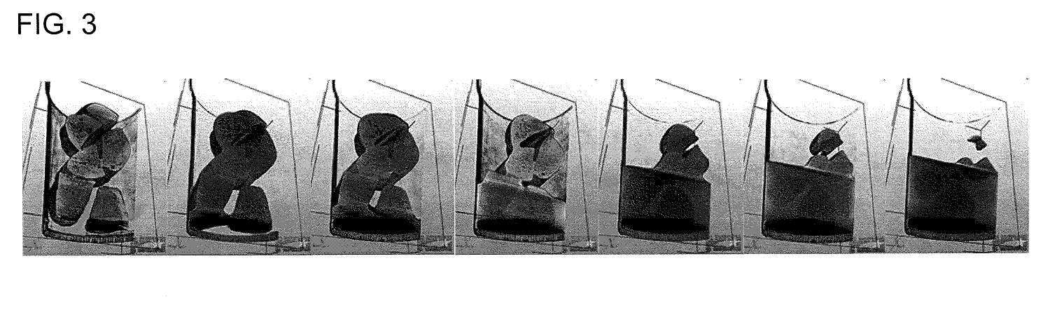

FIG. 3 shows a sequence of images representing a 4D CT scan in the form of a cup with melting ice. This exemplary 4D CT scan illustrates how ice is melting over time. In this example, the CT scanning system 100 used x-rays of 50 kV and 1880 μA, the magnification of 2.15× and a resolution of 59 microns. The x-ray detector 104 generated a 2D image every 0.5 degree. In other words, the x-ray detector 104 generated 720 2D images during each rotation of the cup. The stage 106 rotated the cup 30 times during the entire scan. As a result, the x-ray detector 104 generated 21,600 total 2D images (720×30) of the cup. The size of each projection was 1536×1920 pixels and the total size of the data set was 118 GB. The x-ray detector 104 generated the 2D images at a frame rate of 10 frames per second. Consequently, 100 ms passed between each of the 2D images (i.e., 10 2D images per second=0.1 seconds per 2D image*1000 ms per second=100 ms per 2D image).

In this exemplary 4D CT scan, the user selected an offset value of 90° and a range of 360°. Because the x-ray detector 104 generated a 2D image for every 0.5° of rotation, the offset value of 90° corresponds to 180 frames. This corresponds to 18 seconds (180 frames/10 fps) between each reconstructed 3D image. Thus, the total number of 3D images was 117 (29 rotations after the first rotation×4 images per rotation+1 image from the first rotation=117).

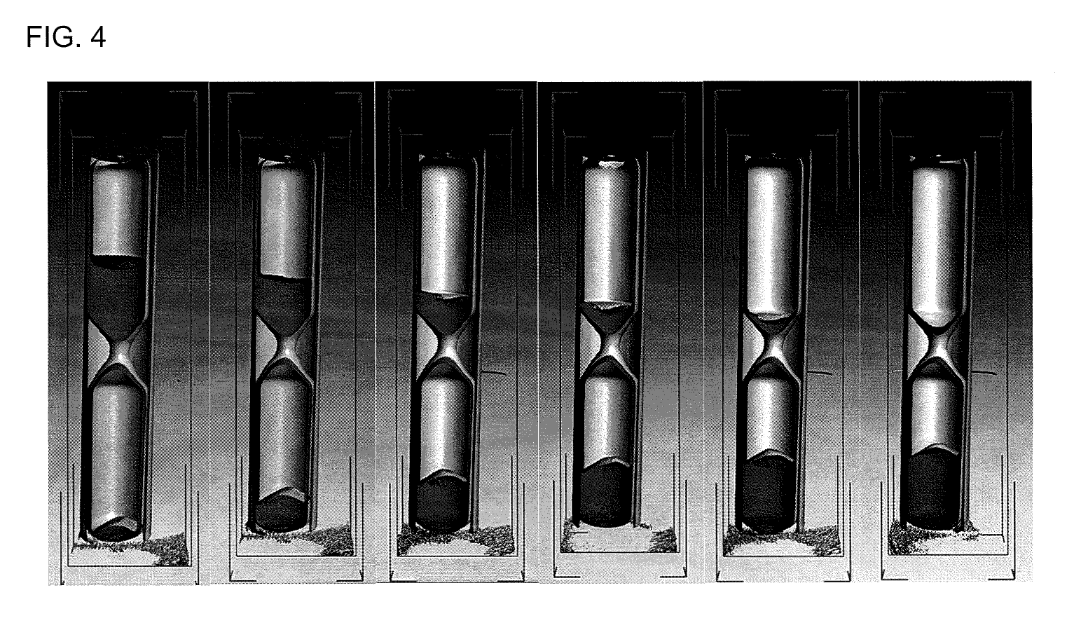

FIG. 4 shows another sequence of images representing a four-dimensional CT scan in the form of an hourglass. This exemplary four-dimensional CT scan illustrates how sand flows through the hourglass. In this example, the CT scanning system 100 used x-rays of 55 kV and 500 μA, a magnification of 1.83×, and a resolution of 138 microns. The x-ray detector 104 generated a 2D image for every 0.5° of rotation. The hourglass was rotated ten times during the entire scan. Consequently, the x-ray detector 104 generated 7,200 total 2D images (720×10) of the hourglass. The size of each projection was 768×480 pixels and the total size of the data set was 5 GB. The x-ray detector 104 generated the 2D images at a frame rate of 56 frames per second. In other words, the x-ray detector 104 generated 56 2D images per second which corresponds to 17.8 ms between each of the generated 2D images. (56 2D images/second=(1/56) seconds/2D image*1000 ms/second=17.8 ms/2D image).

In this exemplary 4D CT scan, the user selected an offset value of 22.5° and a range of 360°. Because the x-ray detector 104 generated 2D images for every 0.5° of rotation, the offset value of 22.5° corresponds to 45 2D images. Because the x-ray detector 104 generated 2D images at a rate of 56 frames per second, the offset value of 22.5° results in 0.8 seconds (45 frames/56 fps) between each reconstructed 3D image. Thus, the total number of 3D images was 145 (9 rotations after the first rotation×16 images per rotation+1 image from the first rotation=145). Because sand flowing through an hourglass is a faster process than melting ice, the user configured the CT scanning system 100 such that the time between each 3D image is shorter in the example shown in FIG. 4 than in the example shown in FIG. 3.

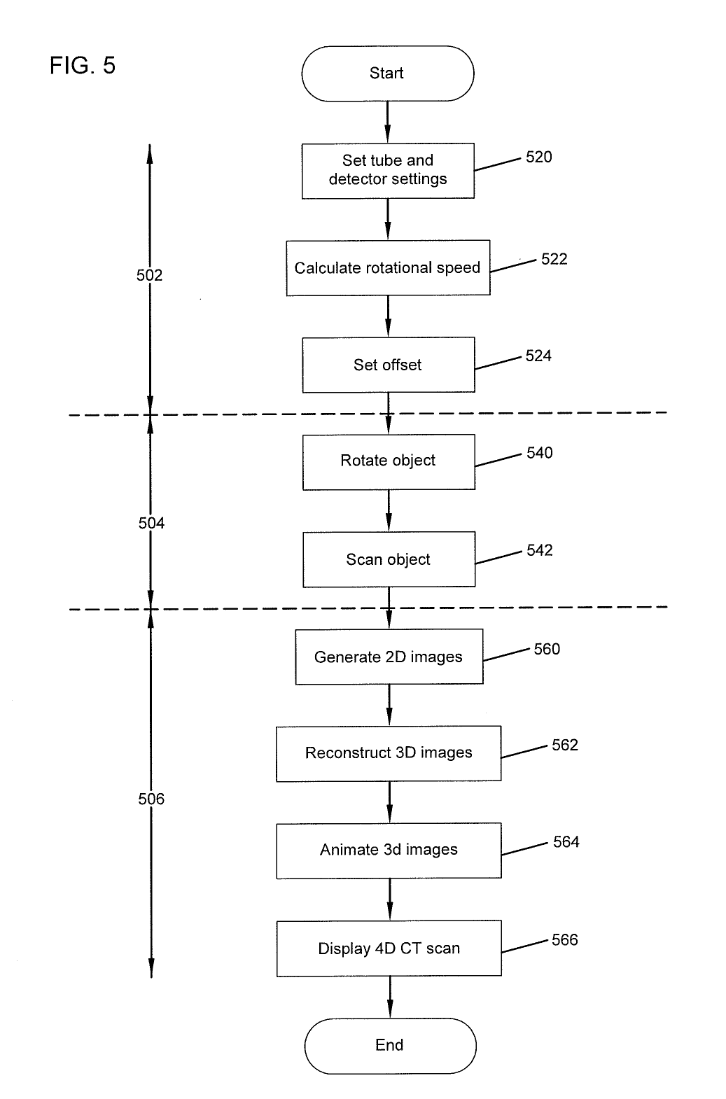

FIG. 5 is a flowchart illustrating an exemplary method of operating the CT scanning system 100. The method includes three periods: a setup period 502, a scanning period 504, and a reconstruction period 506. The setup period 502 includes operations 520, 522, and 524. The scanning period 504 includes operations 540 and 542. The reconstruction period 506 includes operations 560, 562, 564, and 566.

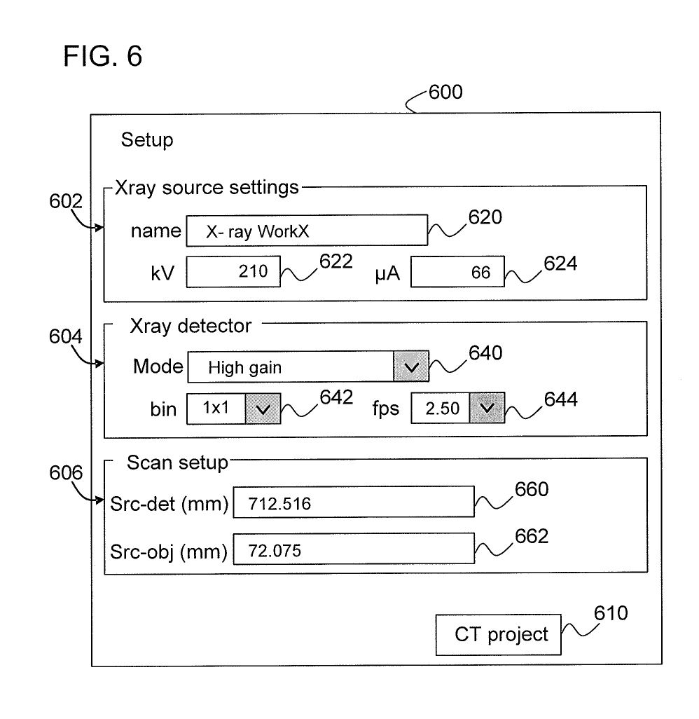

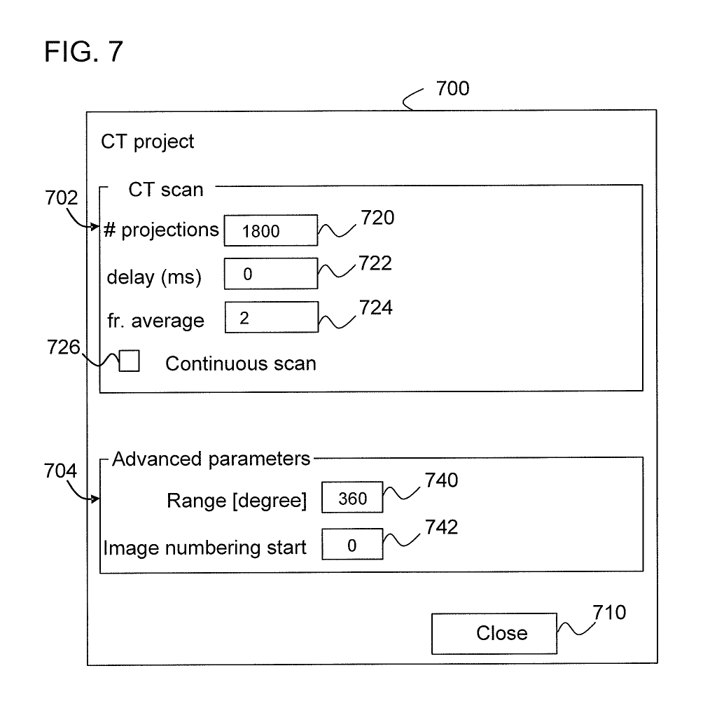

The setup period 502 begins with the operation 520. During the operation 520, the user of the CT scanning system 100 sets the required settings of the x-ray source 102 and the x-ray detector 104 using the input device 212. This is described in more detail below in conjunction with the examples of FIGS. 6 and 7. The user sets, for example, the frame rate of the x-ray detector 104 and the desired number of generated 2D images (projections) over a 360 degree rotation of the object 110 in the operation 520. These input parameters are then used for calculating the rotational speed of the stage 106 in the operation 522. The user sets the offset, thereby controlling the time interval between each reconstructed 3D image in the operation 524.

When the setup period 502 is finished, the scanning period 504 begins. The stage 106 rotates the object 110 in the operation 540 with a rotational speed set in the operation 522. In the operation 542, the CT scanning system 100 scans the object 110. In order to scan the object 110, the CT scanning system 100 radiates the object 110 with x-rays from the x-ray source 102 as the object 110 rotates one or more times. In addition, the x-ray detector 104 measures one or more characteristics of x-rays that have passed through the object 110 and hit pixels of the x-ray detector 104.

The reconstruction period 506 begins with the operation 560. During the operation 560, the x-ray detector 104 generates a series of 2D images of the object 110 using the data collected in the operation 542. The 2D images represent views of the object 110 from different angles. In the operation 562, the 3D reconstruction module 220 reconstructs a series of 3D images. The 3D reconstruction module 220 uses a different subset of the 2D images to reconstruct each of the 3D images. The 3D reconstruction module 220 reconstructs the 3D images such that a frame rate of the 3D images is equal to a rate at which the object 110 rotates by the offset value selected in the operation 524. The 4D viewer 222 generates four-dimensional CT images by animating the reconstructed 3D images in the operation 564. The reconstruction period 506 is concluded by displaying the four-dimensional CT images to the user on the output device 210 in the operation 566.

The flowchart shown in FIG. 5 is made for illustration only and is described, for simplicity, as being a method performing subsequent steps. It is, however, understood that some of the operations described therein may be performed in parallel and simultaneously. For example, the operations 540, 542 and 560 may be performed simultaneously. In some embodiments all of the operations 540-566 are performed simultaneously or in different orders.

FIG. 6 is an example screen illustration comprising an exemplary setup interface 600. The setup interface 600 includes x-ray source settings 602, x-ray detector settings 604, scan setup settings 606, and a navigation control 610.

The x-ray source settings 602 include a field 620 for displaying the name of the x-ray source 102, which in the example of FIG. 6 is “X-ray WorkX.” The x-ray source settings 602 further include fields 622 and 624 for voltage and current selection respectively. In this example, the user has selected the voltage to be 210 kV and has selected the current to be 66 μA.

The x-ray detector settings 604 may include a drop down list 640 for selecting mode of the detector. In this example, the user has selected a high gain mode. The x-ray detector setting 604 may also include a drop down list 642 for selecting binning, i.e. to select resolution. In this example, the user has selected a full resolution (1×1). The x-ray detector setting 604 may further include a drop down list 644 for selecting a frame rate. In this example, the user has selected 2.50 frames per second.

The scan setup settings 606 include a field 660 for selecting a distance between the x-ray source 102 and the x-ray detector 104. In this example, the user has selected the distance between the x-ray source 102 and the x-ray detector 104 to be 712.516 mm. The scan setup settings 606 further include a field 662 for selecting the distance between the x-ray source 102 and the object 110. In this example, the user has selected the distance between the x-ray source 102 and the object 110 to be 72.075 mm.

The user selects the navigation control 610 to jump to a different interface display. By selecting the navigation control 610 which is a CT project button, the control unit 108 displays a CT project setup interface 700 shown in FIG. 7.

The CT project setup interface 700 shown in the example of FIG. 7 includes CT scan settings 702, advanced parameters settings 704, and a navigation control 710. The navigation control 710 is in the form of a close button which is used when the setup is finished.

The CT scan settings 702 include a field 720 for selecting the number of 2D images to generate while scanning the object 110. In the example of FIG. 7, the user has selected 1800 projections to be used while scanning the object 110. The CT scan settings 702 also include a field 722 for selecting a delay. In the example of FIG. 7, the user has selected the delay to be 0 ms. The CT scan settings 702 further includes a field 724 for selecting a frame average to determine from how many frames data is averaged during the data acquisition. In this example, the user has selected the frame average to be 2 frames. The CT scan settings 702 further include a check box 726. The check box 726 is checked when a continuous scan is selected.

The advanced parameters settings 704 include a field 740 for selecting which range to use. In this example, the user has selected a 360° range. The advanced parameters settings 704 further include a field 742 for selecting when to start reconstructing 3D images. In other words, the field 742 allows a user to ignore some available 3D reconstructions. In the example of FIG. 7, the user has selected “0” when to start reconstructing 3D images, which means that all available 3D reconstructions are kept, i.e. all generated 2D images are in fact reconstructed into 3D images. If a value “20” is selected, the first twenty available 3D reconstructions are ignored and only the remaining ones are reconstructed.

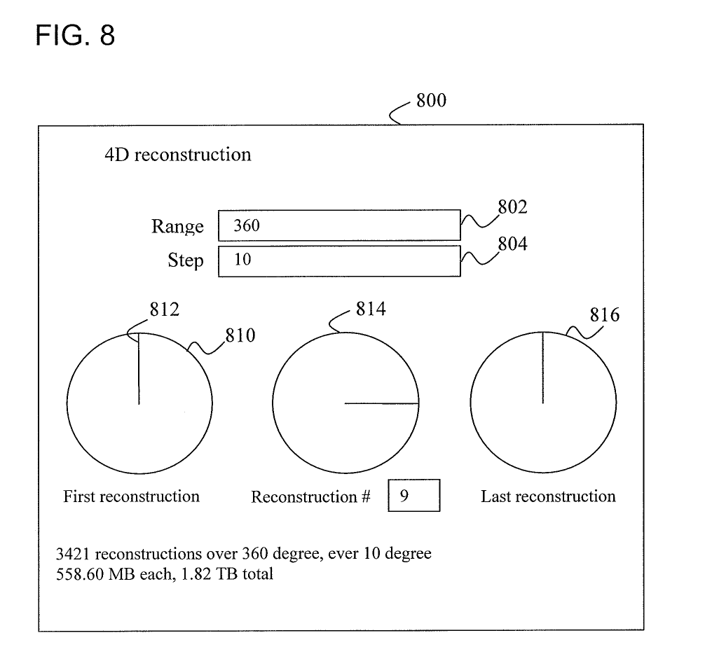

FIG. 8 is a screen illustration of an exemplary 4D reconstruction interface 800. The 4D reconstruction interface 800 includes a reconstruction range field 802 and a reconstruction step field 804. In the 4D reconstruction interface 800, a user can use the reconstruction range field 802 to select a range, discussed above, over which the 3D reconstruction module 220 performs three-dimensional reconstruction, such as 360°, i.e. how the revolution is cut when reconstructing the 3D images. The user can also select the offset discussed above, i.e. the desired time interval between each reconstructed three-dimensional image, in the reconstruction step field 804. In this example, the offset is set to 10°. The three circles 810, 814 and 816 shown on the 4D reconstruction interface 800 are graphical representations of the range and offset (i.e., step). The circle 810 illustrates that when the range is set to 360° and the step is set to 10°, the first 3D image (i.e., reconstruction number zero) is generated using 2D images that start at 0° and end at 360°. The line 812 in the circle 810 indicates 0° and 360°. The circle 814 shows that when the range is set to 360° and the step is set to 10°, the tenth 3D image (i.e., reconstruction number 9) is generated using 2D images that start at 90° (9×10°) and end at 450°. The line in the circle 814 indicates 90° and 450°. In the example of FIG. 8, the user has configured the CT scanning system 100 to rotate ninety-five times. After the object 110 has rotated ninety-five times, the CT scanning system 100 can generate 3,420 3D images. The circle 816 illustrates that when the range is set to 360° and the step is set to 10°, the 3,421^{st} 3D image (i.e., reconstruction number 3,420) is generated using 2D images that start at 34,840° and ends at 34,200°. The line in the circle 816 indicates 33,840° and 34,200°. If the range had been selected in field 802 to be 90° instead of 360°, the circle 810 would have been divided in four sections pointing at 90°, 180°, 270° and 360° respectively.

Four-dimensional CT scanning makes it possible to perform dynamic non-destructive testing/analysis of objects. Applications of four-dimensional CT scanning include: mechanisms in motion, specimen/samples under torsion/traction/compression testing, flow analysis, heating/cooling analysis, chemical testing, fatigue, crash tests and many more. For example, the user wants to study the structural repercussion of compressing a metallic foam object and study the deformations and critical area for failure analysis. The foam structure is complex and no technology exists today to visualize the internal constitution without physically cutting the sample other than x-ray CT. Four-dimensional CT scanning allows the user to study this effect during compression, at any stage, and understand better the effects of foam compression to, ultimately, manufacture more robust structures while optimizing material properties and constitution.

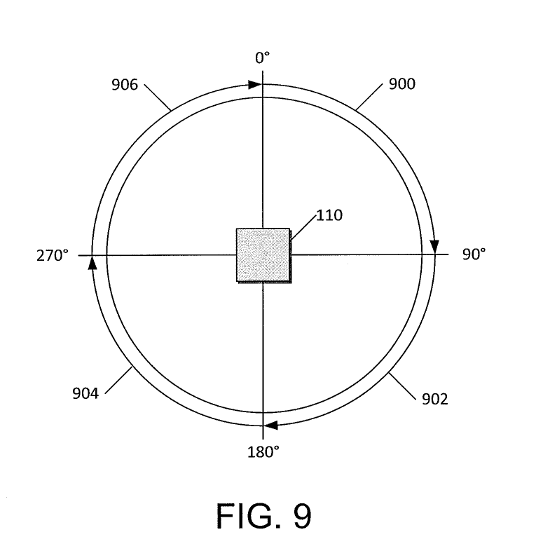

FIG. 9 is a conceptual diagram that illustrates generation of 3D images when a range is set to 90° and an offset value is set to 90°. The example of FIG. 9 illustrates four ranges 900, 902, 904, and 906. The range 900 has a starting point of 0° and an ending point of 90°. The range 902 has a starting point of 90° and an ending point of 180°. The range 904 has a starting point of 180° and an ending point of 270°. The range 906 has a starting point of 270° and an ending point of 360°. The starting points and the ending points of the ranges 900, 902, 904, and 906 are each separated by the range of 90°.

As illustrated in the example of FIG. 9, the 3D reconstruction module 220 generates a first 3D image using 2D images generated as the object 110 rotates through the range 900. The 3D reconstruction module 220 generates a second 3D image using 2D images generated as the object 110 rotates through the range 902. The 3D reconstruction module 220 generates a third 3D image using 2D images generated as the object 110 rotates through the range 904. The 3D reconstruction module 220 generates a fourth 3D image using 2D images generated as the object 110 rotates through the range 906. In this way, when the range is set to 90° and the offset value is set to 90°, the 3D reconstruction module 220 generate four 3D images during each full rotation of the object 110.

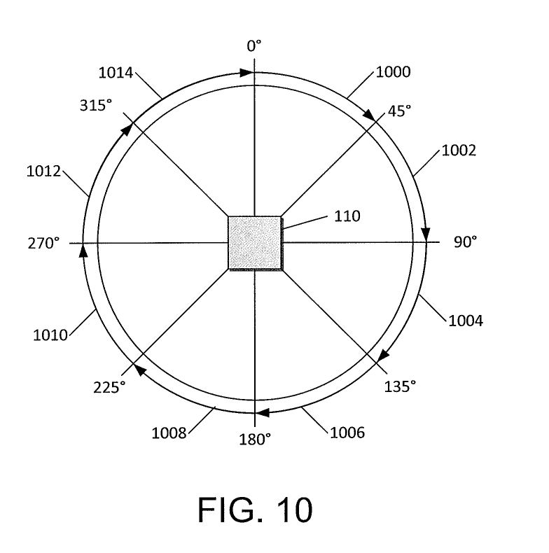

FIG. 10 is a conceptual diagram that illustrates generation of 3D images when a range is set to 45° and an offset value is set to 45°. The example of FIG. 10 illustrates eight ranges 1000, 1002, 1004, 1006, 1008, 1010, 1012, and 1014. The range 1000 has a starting point of 0° and an ending point of 45°. The range 1002 has a starting point of 45° and an ending point of 90°. The range 1004 has a starting point of 90° and an ending point of 135°. The range 1006 has a starting point of 135° and an ending point of 180°. The range 1008 has a starting point of 180° and an ending point of 225°. The range 1010 has a starting point of 225° and an ending point of 270°. The range 1012 has a starting point of 270° and an ending point of 315°. The range 1014 has a starting point of 315° and an ending point of 360°. The starting points and the ending points of the ranges 1000, 1002, 1004, 1006, 1008, 1010, 1012, and 1014 are each separated by a range of 45°.

In the example of FIG. 10, the 3D reconstruction module 220 generates a first 3D image using 2D images captured as the object 110 rotates through the range 1000. The 3D reconstruction module 220 generates a second 3D image using 2D images captured as the object 110 rotates through the range 1002. The 3D reconstruction module 220 generates a third 3D image using 2D images captured as the object 110 rotates through the range 1004. The 3D reconstruction module 220 generates a fourth 3D image using 2D images captured as the object 110 rotates through the range 1006. The 3D reconstruction module 220 generates a fifth 3D image using 2D images captured as the object 110 rotates through the range 1008. The 3D reconstruction module 220 generates a sixth 3D image using 2D images captured as the object 110 rotates through the range 1010. The 3D reconstruction module 220 generates a seventh 3D image using 2D images captured as the object 110 rotates through the range 1012. The 3D reconstruction module 220 generates an eighth 3D image using 2D images captured as the object 110 rotates through the range 1014. In this way, when the range is set to 45° and the offset value is set to 45°, the 3D reconstruction module 220 generate eight 3D images during each full rotation of the object 110. The 3D reconstruction module 220 can generate another set of eight 3D images using images captured during a next rotation of the object 110.

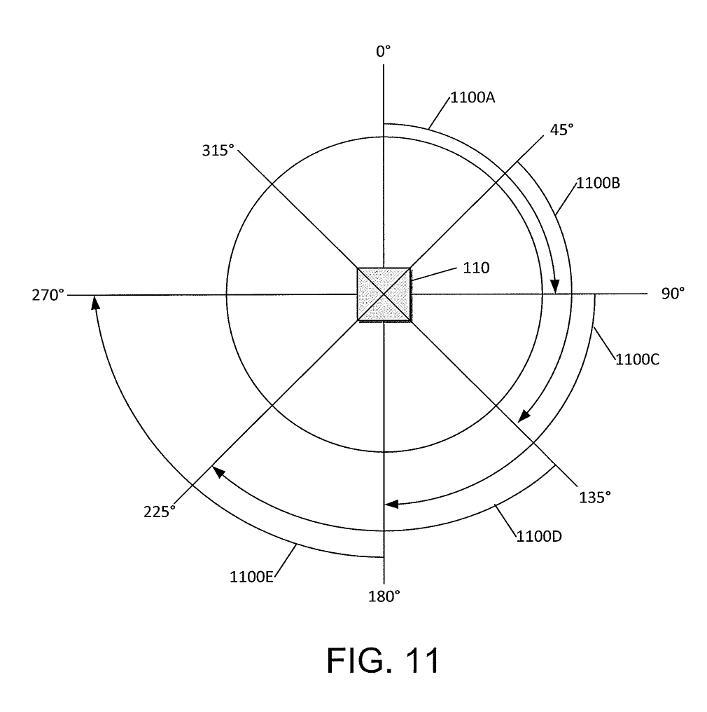

FIG. 11 is a conceptual diagram that illustrates generation of 3D images when a range is set to 90° and an offset value is set to 45°. The example of FIG. 11 illustrates five ranges 1100A, 1100B, 1100C, 1100D, and 1100E (collectively, “ranges 1100”). The starting point of the range 1100A is 0° and the ending point of the range 1100A is 90°. The starting point of the range 1100B is 45° and the ending point of the range 1100B is 135°. The starting point of the range 1100C is 90° and the ending point of the range 1100C is 180°. The starting point of the range 1100D is 135° and the ending point of the range 1100D is 225°. The starting point of the range 1100E is 180° and the ending point of the range 1100E is 270°. Other ranges exist but are omitted from FIG. 11 for clarity.

The starting points and the ending points of each of the ranges 1100 are separated by the range of 90°. For instance, the starting point and the ending point of the range 1100A are separated by 90°, the starting point and the ending point of the range 1100B are separated by 90°, and so on. The starting points of each of the ranges 1100 are separated from each other by the offset value of 45°. Likewise, the ending points of each of the ranges 1100 are separated from each other by the offset value of 45°. For example, the starting point of the range 1100A is separated from the starting point of the range 1100B by 45°. Likewise, in this example, the ending point of the range 1100A is separated from the ending point of the range 1100B by 45°.

The 3D reconstruction module 220 generates a first 3D image using 2D images captured as the object 110 rotates through the range 1100A. The 3D reconstruction module 220 generates a second 3D image using 2D images captured as the object 110 rotates through the range 1100B. The 3D reconstruction module 220 generates a third 3D image using 2D images captured as the object 110 rotates through the range 1100C. The 3D reconstruction module 220 generates a fourth 3D image using 2D images captured as the object 110 rotates through the range 1100D. The 3D reconstruction module 220 generates a fifth 3D image using 2D images captured as the object 110 rotates through the range 1100E. The 3D reconstruction module 220 continues generating 3D images in this manner. In this way, the 3D reconstruction module 220 generates seven 3D images using 2D images captured as the object 110 rotates the first 360° and eight 3D images in the subsequent revolutions.

Each of the ranges 1100 overlaps at least one other one of the ranges 1100. For example, the range 1100B overlaps with the range 1100A from 45° to 90°. Thus, the 3D reconstruction module 220 uses 2D images captured as the object 110 rotated from 45° to 90° when generating both the first 3D image and the second 3D image.

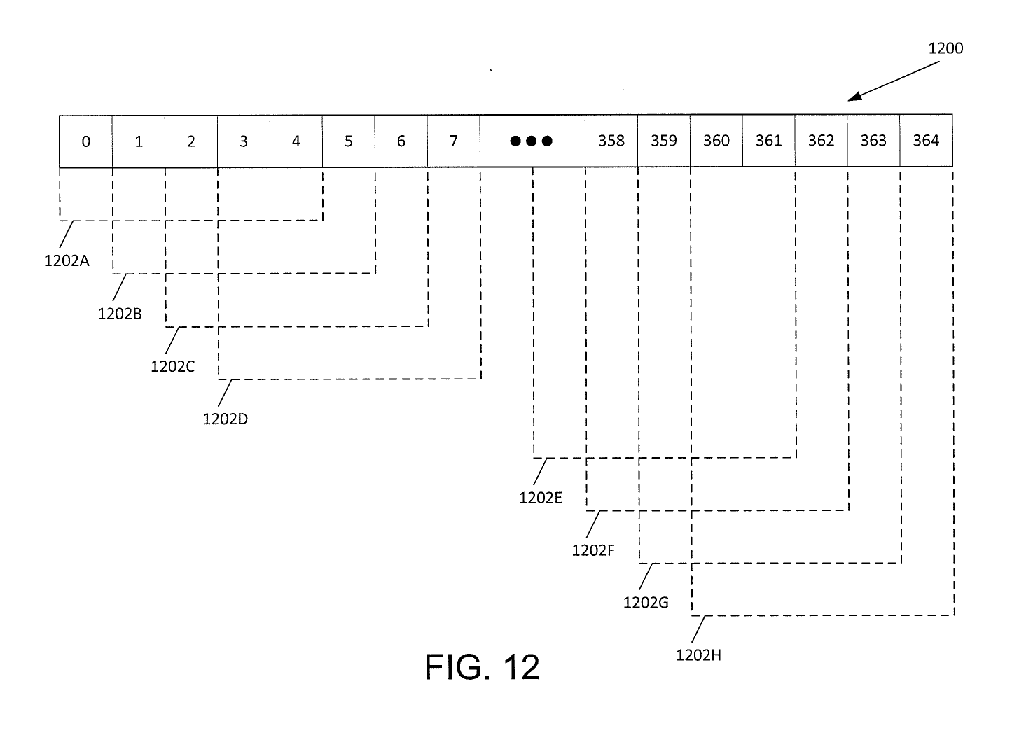

FIG. 12 is a conceptual diagram illustrating subsets of 2D images used to generate 3D images. In the example of FIG. 12, the CT scanning system 100 generates a 2D image each time the object 110 rotates 1°. Furthermore, in the example of FIG. 12, the range is set to 5° and the offset value is set to 1°.

The example of FIG. 12 includes a series of blocks 1200. Each of the blocks 1200 corresponds to a 2D image of the object 110 captured after the object 110 has rotated a different number of degrees. For example, the block “0” corresponds to a 2D image of the object 110 captured after the object 110 has rotated 0°, the block “1” corresponds to a 2D image of the object 110 captured after the object 110 has rotated 1°, and so on. In this example, 2D images are numbered 0 through 364. The reader will understand that there can be additional 2D images after the image numbered 364.

The example of FIG. 12 also includes a series of brackets 1200A-1200H (collectively, “brackets 1200”). Each of the brackets 1200 corresponds to a different subset of the 2D images. For example, the bracket 1200A corresponds to 2D images captured as the object 110 rotated through a range from 0° to 5° (i.e., images 0, 1, 2, 3, and 4), the bracket 1200B corresponds to 2D images captured as the object 110 rotated through a range from 1° to 5° (i.e., images 1, 2, 3, 4, and 5), and so on.

The 3D reconstruction module 220 generates a different 3D image the subset of the 2D images corresponding to each of the brackets 1200. For example, the 3D reconstruction module 220 reconstructs a first 3D image using the 2D images in the subset of the 2D images corresponding to the bracket 1202A (i.e., the 2D images corresponding to blocks “0” through “4”). The 3D reconstruction module 220 reconstruct a second 3D image using the 2D images in the subset of the 2D images corresponding to the bracket 1202B (i.e., the 2D images corresponding to blocks “1” through “5”).

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A computed tomography scanning method for non-destructive analysis of an object, the method comprising:
rotating the object;
radiating the rotating object as the object is being rotated;
generating measurements of radiation that has passed through the object as the object is being rotated;
using the measurements to generate a series of two-dimensional (2D) images of the object, each of the 2D images captured after the object has rotated a different number of degrees;
reconstructing three-dimensional (3D) images of the object from the 2D images;
using the 3D images to generate a four dimensional representation of the object; and
displaying the four dimensional representation of the object.

2. The method of claim 1, wherein reconstructing the 3D images comprises using a given one of the 2D images to reconstruct two or more of the 3D images.

3. The method of claim 1, wherein reconstructing the 3D images comprises:
reconstructing a first 3D image from a first subset of the 2D images, each 2D image in the first subset being of the object as the object rotated through a first range, a starting point of the first range being a first number of degrees that the object has rotated after the object started rotating, an ending point of the first range being a second number of degrees that the object has rotated after the object started rotating;
reconstructing a second 3D image from a second subset of the 2D images, each 2D image in the second subset being of the object as the object rotated through a second range, a starting point of the second range being a third number of degrees that the object has rotated after the object started rotating, an ending point of the second range being a fourth number of degrees that the object has rotated after the object started rotating,
wherein the starting point of the first range is separated from the ending point of the first range by a given range, and the starting point of the second range is separated from the ending point of the second range by the given range.

4. The method of claim 3, further comprising receiving input from a user, the input indicating the given range.

5. The method of claim 1, wherein reconstructing the 3D images comprises reconstructing the 3D images such that a time between each 3D image is equal to a rate at which the object rotates by a number of degrees indicated by an offset value.

6. The method of claim 1, wherein reconstructing the 3D images comprises:
reconstructing a first 3D image from a first subset of the 2D images, each 2D image in the first subset being of the object as the object rotated through a first range, a starting point of the first range being a first number of degrees that the object has rotated after the object started rotating, an ending point of the first range being a second number of degrees that the object has rotated after the object started rotating, the starting point of the first range and the ending point of the first range separated from each other by a given range;
reconstructing a second 3D image from a second subset of the 2D images, each 2D image in the second subset being of the object as the object rotated through a second range, a starting point of the second range being a third number of degrees that the object has rotated after the object started rotating, an ending point of the second range being a fourth number of degrees that the object has rotated after the object started rotating, the starting point of the second range and the ending point of the second range separated from each other by the given range, the starting point of the second range being separated from the starting point of the first range by the number of degrees indicated by the offset value, the ending point of the second range being separated from the ending point of the first degree range by the number of degrees indicated by the offset value.

7. The method of claim 6, further comprising: receiving input from a user, the input indicating the offset value.

8. The method of claim 1, further comprising displaying a structure inside the object by virtually cutting a plane of the displayed four-dimensional representation of the object at a given time.

9. The method of claim 1, wherein the 3D images are generated using 2D images generated during multiple rotations of the object.

10. The method of claim 1, wherein rotating the object comprises rotating the object in a continuous manner

11. A computed tomography (CT) scanning system for non-destructive analysis of an object comprising:
a radiation source arranged to radiate the object;
a detector arranged to measure radiation that has passed through the object;
a stage upon which the object is placed, the stage configured to rotate the object in a continuous or step-by-step manner, the stage located between the radiation source and the detector;
a control unit configured to:
use the measurements to generate a series of two-dimensional (2D) images of the object, each of the 2D images captured after the object has rotated a different number of degrees;
reconstruct three-dimensional (3D) images of the object from the 2D two-dimensional images; and
use the 3D images to generate a four dimensional representation of the object; and
a display unit arranged to display the four-dimensional representation of the object.

12. The CT scanning system of claim 11, wherein the control unit uses a given one of the 2D images to reconstruct two or more of the 3D images.

13. The CT scanning system of claim 12, wherein the control unit:
receives input from a user, the input indicating a given range;
reconstructs a first 3D image from a first subset of the 2D images, each 2D image in the first subset being of the object as the object rotated through a first range, a starting point of the first range being a first number of degrees that the object has rotated after the object started rotating, an ending point of the first range being a second number of degrees that the object has rotated after the object started rotating; and
reconstructs a second 3D image from a second subset of the 2D images, each 2D image in the second subset being of the object as the object rotated through a second range, a starting point of the second range being a third number of degrees that the object has rotated after the object started rotating, an ending point of the second range being a fourth number of degrees that the object has rotated after the object started rotating,
wherein the starting point of the first range is separated from the ending point of the first range by the given range, and the starting point of the second range is separated from the ending point of the second range by the given range.

14. The CT scanning system of claim 12, wherein the control unit:
receives input from a user, the input indicating an offset value; and
generates the 3D images such that a time between each 3D images is equal to a rate at which the object rotates by a number of degrees indicated by the offset value.

15. The CT scanning system of claim 14, wherein the control unit:
reconstructs a first 3D image from a first subset of the 2D images, each 2D image in the first subset being of the object as the object rotated through a first range, a starting point of the first range being a first number of degrees that the object has rotated after the object started rotating, an ending point of the first range being a second number of degrees that the object has rotated after the object started rotating, the starting point of the first range and the ending point of the first range separated from each other by a given range,
reconstructs a second 3D image from a second subset of the 2D images, each 2D image in the second subset being of the object as the object rotated through a second range, a starting point of the second range being a third number of degrees that the object has rotated after the object started rotating, an ending point of the second range being a fourth number of degrees that the object has rotated after the object started rotating, the starting point of the second range and the ending point of the second range separated from each other by the given range, the starting point of the second range being separated from the starting point of the first range by the number of degrees indicated by the offset value, the ending point of the second range being separated from the ending point of the first degree range by the number of degrees indicated by the offset value.

16. The CT scanning system of claim 11, wherein the control unit further is configured to display a structure inside the object by cutting a plane of the displayed four-dimensional representation of the object at a given time.

17. The CT scanning system of claim 11, wherein the stage is configured to rotate the object in a step-by-step manner.

18. A computer readable storage media including program instructions for performing a non-destructive analysis of an object, execution of the program instructions by a computed tomography (CT) scanning system causing the computed tomography scanning system to:
rotate the object in a continuous or step-by-step manner;
radiate the rotating object as the object is being rotated;
generate measurements of radiation that has passed through the object as the object is being rotated;
use the measurements to generate two-dimensional (2D) images of the object, each of the 2D images captured after the object has rotated a different number of degrees;
reconstruct three-dimensional (3D) images of the object from the 2D images;
use the 3D images to generate a four dimensional representation of the object; and
display the four dimensional representation of the object.

19. The computer readable storage media of claim 18, wherein execution of the program instructions by the CT scanning system causes the CT scanning system to use a given one of the 2D images to reconstruct two or more of the 3D images.

20. The computer readable storage media of claim 18, wherein execution of the program instructions by the CT scanning system causes the CT scanning system to:
reconstruct a first 3D image from a first subset of the 2D images, each 2D image in the first subset being of the object as the object rotated through a first range, a starting point of the first range being a first number of degrees that the object has rotated after the object started rotating, an ending point of the first range being a second number of degrees that the object has rotated after the object started rotating;
reconstruct a second 3D image from a second subset of the 2D images, each 2D image in the second subset being of the object as the object rotated through a second range, a starting point of the second range being a third number of degrees that the object has rotated after the object started rotating, an ending point of the second range being a fourth number of degrees that the object has rotated after the object started rotating,
wherein the starting point of the first range is separated from the ending point of the first range by a given range, and the starting point of the second range is separated from the ending point of the second range by the given range.

21. The computer readable storage media of claim 18, wherein execution of the program instructions by the CT scanning system causes the CT scanning system to reconstruct the 3D images such that a time between each 3D image is equal to a rate at which the object rotates by a number of degrees indicated by an offset value.

22. The computer readable storage media according to claim 21, wherein execution of the program instructions by the CT scanning system causes the CT scanning system to:
reconstruct a first 3D image from a first subset of the 2D images, each 2D image in the first subset being of the object as the object rotated through a first range, a starting point of the first range being a first number of degrees that the object has rotated after the object started rotating, an ending point of the first range being a second number of degrees that the object has rotated after the object started rotating, the starting point of the first range and the ending point of the first range separated from each other by a given range;
reconstruct a second 3D image from a second subset of the 2D images, each 2D image in the second subset being of the object as the object rotated through a second range, a starting point of the second range being a third number of degrees that the object has rotated after the object started rotating, an ending point of the second range being a fourth number of degrees that the object has rotated after the object started rotating, the starting point of the second range and the ending point of the second range separated from each other by the given range, the starting point of the second range being separated from the starting point of the first range by the number of degrees indicated by the offset value, the ending point of the second range being separated from the ending point of the first degree range by the number of degrees indicated by the offset value.
